(19) United States
(12) Patent Application Publication
(10) Pub. No.: US 2026/0095214 A1
(43) Pub. Date: Apr. 2, 2026

(54) BEAMFORMING DEVICE AND METHOD OF CALIBRATING AMPLITUDE AND PHASE ERRORS THEREIN

(71) Applicant: ELECTRONICS AND TELECOMMUNICATIONS RESEARCH INSTITUTE, Daejeon (KR)

(72) Inventor: Seong Mo MOON, Daejeon (KR)

(73) Assignee: ELECTRONICS AND TELECOMMUNICATIONS RESEARCH INSTITUTE, Daejeon (KR)

(21) Appl. No.: 19/286,851

(22) Filed: Jul. 31, 2025

(30) Foreign Application Priority Data
Sep. 30, 2024 (KR) 10-2024-0133370

(51) Int. Cl. H04B 7/0426; H04B 17/20; H04B 17/309

(52) U.S. Cl. CPC H04B 7/043; H04B 17/25; H04B 17/309

(57) ABSTRACT

A beamforming device includes a common port for transmitting and receiving signals, multiple input/output ports linked to antenna elements, and transmission/reception channels that apply attenuation and phase shifts to signals. A common port coupler provides a first measurement signal, while channel input/output couplers are linked to each port. A channel selection and signal detection circuit selects a channel and acquires a second measurement signal from its associated coupler. An error discriminator determines amplitude and phase differences by mixing the first and second measurement signals.

### CROSS-REFERENCE TO RELATED APPLICATIONS

This application claims priority to Korean Patent Application No. 10-2024-0133370, filed on Sep. 30, 2024, with the Korean Intellectual Property Office (KIPO), the entire contents of which are hereby incorporated by reference.

### BACKGROUND

### 1. Technical Field

Example embodiments of the present disclosure relate to an error calibration device in a communication device, and more specifically, to a beamforming device capable of calibrating an amplitude error and a phase error between beamforming channels in signal transmission and reception using beamforming. The present disclosure also relates to a method of calibrating an amplitude error and a phase error between beamforming channels in a communication device that transmits and receives signals using beamforming, and a signal transmission and reception device suitable for implementing the method.

### 2. Related Art

With the popularization of services requiring wide-bandwidth communication, such as augmented reality (AR), virtual reality (VR), Internet of Things (IoT), and real-time high-definition streaming, wireless mobile communication networks are required to achieve a data transmission rate of about 100 Gbps or higher in the near future. In order to smoothly support these services, a 5G communication system has been commercialized and research on new transmission technologies for 6G communication systems is also actively underway. In order to satisfy system requirements of the 5G and 6G communication systems, it is essential to use a wider communication bandwidth than a bandwidth used in a frequency band of existing 4G LTE communication. Accordingly, a 28 GHz band, which is a millimeter wave (mmWave) band, is being used, and research on technologies for effectively using a terahertz (THz) frequency band, that is, 100 GHz to 10 THz, is also actively underway.

Radio signals in the millimeter wave or terahertz band have the disadvantages of exhibiting strong directivity, low refraction, and severe path loss. To overcome problems caused by the directivity and the path loss, an array antenna including a large number of antenna elements is used, and beamforming is applied to improve an overall antenna gain and directionality by adjusting amplitudes and phases of signals supplied to the respective antenna elements and synthesizing beams of the antenna elements.

However, amplitude and phase errors of a signal may exist between antenna elements for various reasons, and be amplified due to short wavelengths of radio signals in the millimeter wave or terahertz band. For example, a phase of an output signal may have a different value depending on a magnitude of an input signal due to the nonlinearity of a power amplifier. When connecting components such as transmission lines are not manufactured in the same size and shape, changes in magnitude and phase of a signal may occur. Thus, when an error in amplitude or phase occurs between the antenna elements or signal paths due to, for example, deviation between the components, a direction of a synthesized beam may become distorted and a side lobe level may increase, which may adversely affect transmission speed. Therefore, it is necessary to measure a signal of each signal path and correct the signal to have an accurate gain and phase.

### SUMMARY

Example embodiments of the present disclosure provide a beamforming device capable of calibrating an amplitude error and a phase error between beamforming channels in signal transmission and reception using beamforming.

Example embodiments of the present disclosure also provide a method of calibrating an amplitude error and a phase error between beamforming channels in a communication device that transmits and receives signals using beamforming.

Example embodiments of the present disclosure also provide a signal transmission and reception device including the beamforming device and being capable of calibrating an amplitude error and a phase error between beamforming channels.

According to a first exemplary embodiment of the present disclosure, a beamforming device may comprise: a common port configured to receive a transmission signal and output a reception signal to the outside; a plurality of input and output ports connected to corresponding antenna elements and configured to output a radio frequency (RF) transmission signal to the corresponding antenna elements and receive an RF reception signal from the antenna elements; a plurality of transmission and reception channels connected to corresponding input and output ports among the plurality of input and output ports and configured to attenuate and phase-shift respective channel transmission signals to generate the RF transmission signal, and attenuate and phase-shift the RF reception signal from the corresponding input and output ports to generate respective channel reception signals; a common port coupler coupled to the common port and configured to provide a first measurement signal representing the transmission signal or the reception signal; a plurality of channel input and output couplers coupled to the plurality of input and output ports; a channel selection and signal detection circuit configured to select one of the plurality of transmission and reception channels and acquire a second measurement signal detected by a channel input and output coupler associated with the selected transmission and reception channel; and an error discriminator configured to determine an amplitude difference and a phase difference between the first measurement signal and the second measurement signal based on mixing of the first and second measurement signals.

The error discriminator may include: an error signal generator configured to mix the first and second measurement signals to generate an I-channel error signal and a Q-channel error signal; and an analog-to-digital conversion circuit configured to perform analog-to-digital conversion on the I-channel error signal and the Q-channel error signal to generate an I-channel error value and a Q-channel error value.

The error signal generator may generate the I-channel error signal and the Q-channel error signal by additively mixing the first measurement signal and the second measurement signal.

The error discriminator may determine the amplitude difference and the phase difference based on the I-channel error value and the Q-channel error value, and may determine the amplitude error and the phase error based on the amplitude difference and the phase difference.

The beamforming device may further comprise: a controller configured to control an operation of the beamforming device, wherein the error signal generator may output the I-channel error value and the Q-channel error value to an external control device configured to determine the amplitude difference and the phase difference, and the controller may receive an attenuation amount and a phase shift amount corresponding to the amplitude difference and the phase difference from the external control device, store the attenuation amount and the phase shift amount in a storage device, and control the plurality of transmission and reception channels based on the attenuation amount and the phase shift amount.

The controller may control the beamforming circuit so that the beamforming circuit sequentially acquires the amplitude difference and the phase difference for each of the plurality of transmission and reception channels.

The channel selection and signal detection circuit may deactivate paths of outputs of channel input and output couplers associated with the transmission and reception channels not selected among the plurality of transmission and reception channels.

The control unit may control the channel selection and signal detection circuit so that the error discriminator separately determines the amplitude difference and the phase difference for signal transmission and signal reception.

According to a second exemplary embodiment of the present disclosure, a method of calibrating an amplitude error and a phase error between a plurality of transmission and reception channels in signal transmission and reception using beamforming, the method may comprise: coupling a common port coupler to a common port configured to receive a transmission signal and output a reception signal to the outside, to acquire a first measurement signal; selecting any one of the plurality of transmission and reception channels configured to attenuate and phase-shift each channel transmission signal to generate a radio frequency (RF) transmission signal, output the RF transmission signal to a corresponding antenna element, receive an RF reception signal from the corresponding antenna element, and attenuate and phase-shift the RF reception signal, and acquiring a second measurement signal detected by a channel input and output coupler associated with the selected transmission and reception channel; and mixing the first and second measurement signals to determine an amplitude difference and a phase difference between the first measurement signal and the second measurement signal.

The determining of the amplitude difference and the phase difference may include: additively mixing the first measurement signal and the second measurement signal to generate an I-channel error signal and a Q-channel error signal; performing analog-to-digital conversion on the I-channel error signal and the Q-channel error signal to generate an I-channel error value and a Q-channel error value; and determining the amplitude difference and the phase difference based on the I-channel error value and the Q-channel error value.

The determining of the amplitude difference and the phase difference may further include determining an attenuation amount and a phase shift amount corresponding to the amplitude difference and the phase difference, respectively; and operations of the plurality of transmission and reception channels may be controlled based on the attenuation amount and the phase shift amount.

The amplitude difference and the phase difference may be sequentially determined for the plurality of transmission and reception channels.

The acquiring of the second measurement signal may include deactivating paths of outputs of channel input and output couplers associated with the transmission and reception channels not selected among the plurality of transmission and reception channels.

The amplitude difference and the phase difference may be separately determined for signal transmission and signal reception.

According to a third exemplary embodiment of the present disclosure, a signal transmission and reception device may comprise: a baseband signal processing unit configured to perform digital signal processing on transmission data and reception data in a baseband; an RF chain configured to perform digital-to-analog conversion on the transmission data, modulate an obtained analog signal to generate a transmission signal, demodulate a reception signal, and perform analog-to-digital conversion on the reception signal to restore the reception data; an array antenna including a plurality of antenna elements; and a beamforming circuit including a plurality of transmission and reception channels corresponding to the plurality of antenna elements, the beamforming circuit distributing the transmission signal to the plurality of transmission and reception channels, performing signal attenuation and phase shift individually for each transmission and reception channel to generate RF transmission signals, supplying the RF transmission signals to corresponding antenna elements, receiving an RF reception signal from the corresponding antenna element for each transmission and reception channel, performing signal attenuation and phase shift on the RF reception signal, and combining the attenuated and phase-shifted signals for the plurality of transmission and reception channels to generate the reception signal, wherein the beamforming circuit may include: a common port configured to receive the transmission signal and output the reception signal to the RF chain; a plurality of input and output ports connected to the corresponding antenna element and configured to output the RF transmission signal to the corresponding antenna element and receive the RF reception signal from the antenna element; a common port coupler coupled to the common port and configured to provide a first measurement signal representing the transmission signal or the reception signal; a plurality of channel input and output couplers coupled to the plurality of input and output ports; a channel selection and signal detection circuit configured to select any one of the plurality of transmission and reception channels and acquire a second measurement signal detected by a channel input and output coupler associated with the selected transmission and reception channel; and an error discriminator configured to determine an amplitude difference and a phase difference between the first measurement signal and the second measurement signal based on mixing of the first and second measurement signals.

The error discriminator may include: an error signal generator configured to additively mix the first and second measurement signals to generate an I-channel error signal and a Q-channel error signal; and an analog-to-digital conversion circuit configured to perform analog-to-digital conversion on the I-channel error signal and the Q-channel error signal to generate an I-channel error value and a Q-channel error value.

The error discriminator may determine the amplitude difference and the phase difference based on the I-channel error value and the Q-channel error value, and determine the amplitude error and the phase error based on the amplitude difference and the phase difference.

The beamforming circuit may further include a controller configured to control an operation of the beamforming device, the signal transmission and reception device may further include an external control device configured to determine the amplitude difference and the phase difference based on the I-channel error value and the Q-channel error value, and the controller may receive an attenuation amount and a phase shift amount corresponding to the amplitude difference and the phase difference from the external control device, store the attenuation amount and the phase shift amount in a storage device, and control the plurality of transmission and reception channels based on the attenuation amount and the phase shift amount.

The controller may control the beamforming circuit so that the beamforming circuit sequentially acquires the amplitude difference and the phase difference for each of the plurality of transmission and reception channels.

The channel selection and signal detection circuit may deactivate paths of outputs of channel input and output couplers associated with the transmission and reception channels not selected among the plurality of transmission and reception channels.

According to example embodiments, in a communication device that transmits and receives signals using beamforming, it is possible to sequentially measure beamforming signals, compare the beamforming signals with setting data stored in a lookup table (LUT), and quickly and effectively determine and calibrate the amplitude error and the phase error for each transmission and reception channel.

This makes it possible to effectively calibrate a phase and amplitude mismatch between transmission and reception channels that occurs in a circuit implementation, beam pattern change, and an environment. In particular, it is possible to implement a multi-beam antenna system including a small low-power onboard automatic calibration circuit, and to confirm an error occurring during manufacturing to simplify a calibration algorithm.

According to example embodiments, when the amplitude error and the phase error of each transmission and reception channel are determined, a reception signal and a reference signal are additively mixed to determine the amplitude error and the phase error, and a separate local oscillation (LO) signal or an I/Q mixer is not used. Each determined transmission and reception channel is immediately calibrated using the LUT from a phase and gain of the transmission and reception channel. Accordingly, there is an advantage of being less sensitive to a frequency and having no problems due to LO or DC offset.

### BRIEF DESCRIPTION OF DRAWINGS

FIG. 1 is a block diagram of an example embodiment of a signal transmission and reception device to which a calibration method of the present disclosure can be applied.

FIG. 2 is a detailed block diagram of the beamforming circuit 30 according to an example embodiment illustrated in FIG. 1.

FIG. 3 is a more detailed block diagram of the beamforming circuit 30 of FIG. 2 according to an example embodiment.

FIG. 4 is a detailed block diagram of the error discriminator 380 illustrated in FIGS. 2 and 3 according to an example embodiment.

FIG. 5 is a detailed block diagram of an error signal generator 400 illustrated in FIG. 4 according to an example embodiment.

FIG. 6 is a diagram illustrating signal paths of a measurement signal and a reference signal used for determining a transmission amplitude error and a transmission phase error for a first transmission/reception channel.

FIG. 7 is a diagram illustrating signal paths of a measurement signal and a reference signal used for determining a transmission amplitude error and a transmission phase error for a fourth transmission/reception channel.

FIG. 8 is a diagram illustrating signal paths of a measurement signal and a reference signal used for determining a reception amplitude error and a reception phase error for a first transmission/reception channel.

FIG. 9 is a diagram illustrating signal paths of a measurement signal and a reference signal used for determining a reception amplitude error and a reception phase error for a fourth transmission/reception channel.

FIG. 10 is a graph showing measurement results for the amplitude error and the phase error during reception for the first transmission and reception channel 200a.

FIG. 11 shows an antenna radiation pattern when a beamforming circuit calibration method according to an example embodiment is applied to the array antenna.

### DETAILED DESCRIPTION OF THE EMBODIMENTS

Exemplary embodiments of the present disclosure are disclosed herein. However, specific structural and functional details disclosed herein are merely representative for purposes of describing exemplary embodiments of the present disclosure. Thus, exemplary embodiments of the present disclosure may be embodied in many alternate forms and should not be construed as limited to exemplary embodiments of the present disclosure set forth herein. Accordingly, while the present disclosure is capable of various modifications and alternative forms, specific exemplary embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular exemplary embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, exemplary embodiments of the present disclosure will be described in greater detail with reference to the accompanying drawings. In order to facilitate general understanding in describing the present disclosure, the same components in the drawings are denoted with the same reference signs, and repeated description thereof will be omitted.

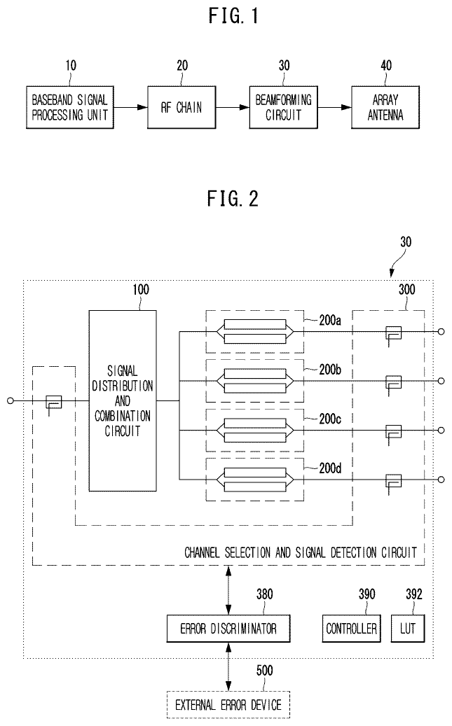

FIG. 1 is a block diagram of an example embodiment of a signal transmission and reception device to which a calibration method of the present disclosure can be applied. The signal transmission and reception device may include a baseband signal processing unit 10, a radio frequency (RF) chain 20, a beamforming circuit 30, and an array antenna 40.

The baseband signal processing unit 10 may perform digital signal processing in a baseband on transmission data and perform digital signal processing in the baseband on reception data. The RF chain 20 performs digital-to-analog conversion on the transmission data and modulates an analog signal to generate a transmission signal. In addition, the RF chain 20 receives a reception signal from the beamforming circuit 30, demodulates the reception signal, and performs analog-to-digital conversion to restore the reception data.

The beamforming circuit 30 includes the plurality of transmission and reception channels corresponding to a plurality of antenna elements in the array antenna 40, distributes the transmission signal from the RF chain 20 to the plurality of transmission and reception channels, individually performs signal attenuation and phase shift on the respective transmission and reception channels to generate RF transmission signals, and supplies the RF transmission signals to the corresponding antenna elements of the array antenna 40. In addition, the beamforming circuit 30 receives an RF reception signal from the corresponding antenna element of the array antenna 40 for each transmission and reception channel, performs signal attenuation and phase shift on the RF reception signal, combines the attenuated and phase-shifted signals for the plurality of transmission and reception channels to generate a reception signal, and supplies the reception signal to the RF chain 20. The array antenna 40 radiates the RF transmission signals from the beamforming circuit 30, through the antenna elements, so that a beam radiation pattern corresponding to the RF transmission signals is formed. In addition, the antenna elements of the array antenna 40 detect received radio waves and supply detected RF received signals to the corresponding channels of the beamforming circuit 30.

FIG. 1 illustrates a signal transmission and reception device using an analog beamforming scheme in which only one RF chain 20 is used, but the present disclosure is not limited to the analog beamforming scheme and may be applied to digital beamforming or hybrid beamforming. In the digital beamforming, the number of RF chains equal to the number of antenna elements in the array antenna 40 or the total number of channels in the beamforming circuit 30 may be used. In the hybrid beamforming, a plurality of RF chains are used, but the number of RF chains may be smaller than the number of antenna elements in the array antenna 40. Therefore, in the following description, the number of antenna elements, the number of RF chains, and/or the number of channels in the beamforming circuit 30 is presented as an example, and it should be noted that the numbers or relative ratios of the numbers are not limited to the illustrated ones or the following exemplary description.

FIG. 2 is a detailed block diagram of the beamforming circuit 30 according to an example embodiment illustrated in FIG. 1. According to the present embodiment, the beamforming circuit 30 includes a signal distribution and combination circuit 100, a plurality of transmission and reception channels 200a to 200d, a channel selection and signal detection circuit 300, an error discriminator 380, and a controller 390. Meanwhile, in FIG. 2, an external control device 500 that externally controls an operation of the beamforming circuit 30 and error calibration is also illustrated.

The signal distribution and combination circuit 100 may amplify the transmission signal input through a common port P0 and distribute the amplified transmission signal to the plurality of transmission and reception channels 200a to 200d. In addition, the signal distribution and combination circuit 100 may combine first to fourth reception signals received through the transmission and reception channels 200a to 200d, amplify the combined reception signal, and output the resultant reception signal through the common port P0.

Each of the plurality of transmission and reception channels 200a to 200d includes a transmission path and a reception path. The transmission path is activated in a transmission mode, receives the transmission signal distributed from the RF chain 20, performs signal attenuation and phase shift on the distributed transmission signal to generate an RF transmission signal, and outputs the RF transmission signal to the corresponding antenna element of the array antenna 40. In addition, the reception path is activated in a reception mode, receives the RF reception signal from the corresponding antenna element of the array antenna 40, and performs signal attenuation and phase shift on the RF reception signal. The signal attenuation and phase shift in the transmission path and the reception path of each of the transmission and reception channels 200a to 200d may be performed according to values stored in a register.

The channel selection and signal detection circuit 300 and the error discriminator 380 do not operate in a normal operation mode for transmitting and receiving a beamforming signal, and may operate only in an error detection mode for determining the amplitude error and the phase error for each of the plurality of transmission and reception channels 200a to 200d. The channel selection and signal detection circuit 300 selects one channel for which the amplitude error and the phase error are to be determined from among the plurality of transmission and reception channels 200a to 200d in response to a command from the controller 390. The selection of the transmission and reception channels may be performed sequentially. In addition, the channel selection and signal detection circuit 300 may acquire a measurement signal and a reference signal to be used for determination of the amplitude error and the phase error during transmission or reception for the selected transmission and reception channel.

The error discriminator 380 may discriminate the amplitude error and the phase error during transmission or reception for each transmission and reception channel based on the measurement signal and the reference signal acquired by the channel selection and signal detection circuit 300. As will be described below, the error discriminator 380 according to the example embodiment may include a structure such as an additive mixing-based direct conversion receiver, and may generate error signals by additively mixing the measurement signal and the reference signal for a transmission or reception operation for each of the transmission and reception channels 200a to 200d, and determine the amplitude error and the phase error.

The controller 390 controls the execution of the normal operation mode and the error detection mode. A register 392 may store a signal attenuation amount and a phase shift amount in the transmission path and the reception path for each transmission and reception channel. The controller 390 may control attenuation and phase shift operations in the normal operation mode and the error detection mode according to the values stored in the register 392. The controller 390 may be interfaced to the external control device 500 by, for example, a serial peripheral interface (SPI), and may control the operation in the normal operation mode and the error detection mode and update the register 392 under the control of the external control device 500. The external control device 500 may be an operator personal computer (PC) that controls an operation of the signal transmission and reception device on-site or remotely.

In one embodiment, a final determination of the amplitude error and the phase error for each of the plurality of transmission and reception channels 200a to 200d is made by the error discriminator 380, and the amplitude error and the phase error or an amplitude error calibration value and a phase error calibration value may be transferred to the controller 390 and the external control device 500. However, in a modified embodiment, the final determination of the amplitude error and the phase error for each channel may be made by the external control device 500, and the amplitude error and the phase error or the amplitude error calibration value and the phase error calibration value may be transferred to the controller 390.

In one embodiment, the external control device 500 may have or access a lookup table (LUT; not shown). The LUT may store data for an attenuation amount in the attenuator according to the discriminated amplitude error, and data for the phase shift amount in the phase shifter according to the phase error. When the amplitude error and the phase error for each channel are discriminated, the external control device 500 may determine a corresponding attenuation amount and phase shift amount and provide the attenuation amount and phase shift amount to the controller 390, so that the controller 390 can store the attenuation amount and phase shift amount in the register 392 and apply the attenuation amount and phase shift amount to the corresponding channel.

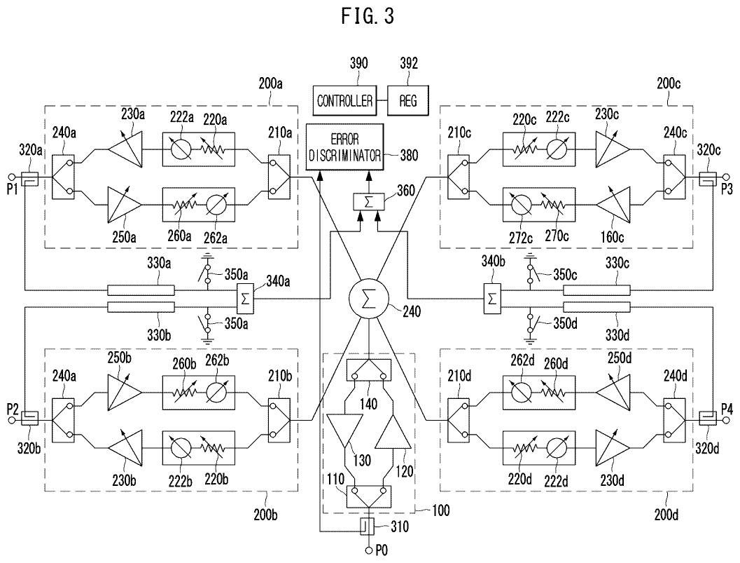

FIG. 3 is a more detailed block diagram of the beamforming circuit 30 of FIG. 2 according to an example embodiment.

According to the present embodiment, the signal distribution and combination circuit 100 may include a switch 110, a transmission signal amplifier 120, a reception signal amplifier 130, a switch 140, and a divider/combiner 150.

The switch 110 connects an input terminal of the transmission signal amplifier 120 to the common port P0 when the beamforming circuit 30 operates in a signal transmission mode or operates as a signal transmission device. On the other hand, when the beamforming circuit 30 operates in a signal reception mode or operates as a signal reception device, the switch 110 connects an output terminal of the reception signal amplifier 130 to the common port P0. The transmission signal amplifier 120 amplifies the transmission signal supplied through the common port P0. The reception signal amplifier 130 may amplify the combined reception signal supplied from the divider/combiner 150 and output the resultant reception signal through the common port P0. The switch 140 may connect either an output terminal of the transmission signal amplifier 120 or an input terminal of the reception signal amplifier 130 to the divider/combiner 150. The divider/combiner 150 may distribute the transmission signal amplified by the transmission signal amplifier 120 to the plurality of transmission and reception channels 200a to 200d. In addition, the divider/combiner 150 may combine signals received by the plurality of transmission and reception channels 200a to 200d and supply the combined reception signal to the reception signal amplifier 130.

The transmission signal amplifier 120 may be implemented by a distributed amplifier, such as a wideband multigated transistor linear distributed amplifier. The reception signal amplifier 130 may also be implemented by a transmission signal distribution amplifier. The switches 110 and 140 may be implemented by, for example, a high-power differential single-pole double-throw (SPDT) switch. The divider/combiner 150 may include a differential 4-way power divider.

The first transmission and reception channel 200a may include a switch 210a, an attenuator 220a, a phase shifter 222a, a power amplifier 230a, a switch 240a, a low-noise amplifier 250a, an attenuator 260a, and a phase shifter 262a. The attenuator 220a, the phase shifter 222a, and the power amplifier 230a may form a transmission path, and the low-noise amplifier 250a, the attenuator 260a, and the phase shifter 262a may form a reception path. Switches 240a and 210a installed at both ends of the transmission path and the reception path may be implemented by, for example, a single-pole double-throw (SPDT) switch and may select the transmission path and the reception path.

In the transmission path, the attenuator 220a may attenuate an amplitude of a first transmission signal distributed by the divider/combiner 150, and the phase shifter 222a may shift a phase of the attenuated signal. The attenuation and the phase shift performed by the attenuator 220a and the phase shifter 222a may be performed according to preset values stored in the register 392. The attenuator 220a and the phase shifter 222a are implemented as a single variable gain phase shifter (VG-PS) rather than being provided separately so that gain adjustment and the phase shift can be performed at once. The power amplifier 230a amplifies the phase-shifted signal. The amplified signal may be supplied to the corresponding antenna element as a first RF transmission signal through the switch 240a and the first input and output port P1.

In the reception path, the low-noise amplifier 250a may receive a first RF reception signal from the antenna element through the first input and output port P1 and the switch 240a and amplify the first RF reception signal. The attenuator 260a may attenuate an amplitude of the amplified first RF reception signal, and the phase shifter 262a may shift a phase of the attenuated signal. The attenuation and the phase shift performed by the attenuator 260a and the phase shifter 262a respectively may be performed according to the preset values stored in the register 392. The attenuator 260a and the phase shifter 262a may be implemented as a single variable gain phase shifter (VG-PS) rather than being provided separately so that gain adjustment and phase shift may be performed at once. The phase-shifted first reception signal may be combined with signals of the other transmission and reception channels 200b to 200d by the divider/combiner 150.

The second transmission and reception channel 200b may be configured similarly to the first transmission and reception channel 200a. In the second transmission and reception channel 200b, an attenuator 220b, a phase shifter 222b, and a power amplifier 230b form a transmission path, which may attenuate a second transmission signal distributed by the divider/combiner 150 and shift a phase of the second transmission signal to generate a second RF transmission signal, and supply the second RF transmission signal to the corresponding antenna element through the second input and output port P2. A low-noise amplifier 250b, an attenuator 260b, and a phase shifter 262b form a reception path, which may receive a second RF reception signal from the antenna element through the second input and output port P2, amplify the second RF reception signal, attenuate the amplified second RF reception signal, and shift a phase of the second RF reception signal to generate a second reception signal, and supply the second reception signal to the divider/combiner 150.

The third transmission and reception channel 200c may be configured similarly to the first transmission and reception channel 200a. In the third transmission and reception channel 200c, an attenuator 220c, a phase shifter 222c, and a power amplifier 230c form a transmission path, which may attenuate a second transmission signal distributed by the divider/combiner 150 and shift a phase of the second transmission signal to generate a third RF transmission signal, and supply the third RF transmission signal to the corresponding antenna element through the third input and output port P3. A low-noise amplifier 250c, an attenuator 260c, and a phase shifter 262c form a reception path, which may receive a third RF reception signal from the antenna element through the third input and output port P3, amplify the third RF reception signal, attenuate the amplified second RF reception signal, shift a phase of the second RF reception signal to generate a second reception signal, and supply the second reception signal to the divider/combiner 150.

The fourth transmission and reception channel 200d may be configured similarly to the first transmission and reception channel 200a. In the fourth transmission and reception channel 200d, an attenuator 220d, a phase shifter 222d, and a power amplifier 230d form a transmission path, which may attenuate the second transmission signal distributed by the power distributor 240 and shift a phase of the second transmission signal to generate a fourth RF transmission signal, and supply the fourth RF transmission signal to the corresponding antenna element through the fourth input and output port P4. A low-noise amplifier 250d, an attenuator 260d, and a phase shifter 262d form a reception path, which may receive a fourth RF reception signal from the antenna element through the fourth input and output port P4, amplify the fourth RF reception signal, attenuate the amplified second RF reception signal, shift a phase of the second RF reception signal to generate the second reception signal, and supply the second reception signal to the divider/combiner 150.

The channel selection and signal detection circuit 300 includes a common port coupler 310, first to fourth couplers 320a to 320d, first to fourth transmission lines 330a to 330d, first and second couplers 340a and 340b, first to fourth switches 350a to 350d, and a third coupler 360.

The common port coupler 310 may be coupled to the common port P0, and may extract a part of signal power transmitted and received through the common port P0 to branch the transmission signal received from the RF chain 20 or the reception signal provided to the RF chain 20, and provide the branched signal to the error discriminator 380. That is, when the amplitude error and the phase error during signal transmission for any one of the first to fourth transmission and reception channels 200a to 200d need to be determined, the transmission signal branched by the common port coupler 310 may be provided to the error discriminator 380 as a transmission reference signal for determining the amplitude error and the phase error. Meanwhile, when the amplitude error and the phase error during signal reception for any one of the first to fourth transmission and reception channels 200a to 200d need to be determined, the reception signal branched by the common port coupler 310 may be provided to the error discriminator 380 as a reception measurement signal for determining the amplitude error and the phase error.

The first to fourth couplers 320a to 320d may be coupled to the first to fourth input and output ports P1 to P4, respectively, to extract a portion of signal power transmitted and received through the respective ports and branch a transmitted and received signal, that is, the first RF transmission signal or the first RF reception signal. A Lange coupler may be used as the common port coupler 310 and the first to fourth couplers 320a to 320d. However, the present disclosure is not limited thereto, and other types of couplers such as a branch-line coupler, a ring hybrid coupler, and a Wilkinson coupler may be used.

The first transmission line 330a includes a first end connected to the first coupler 320a. The second transmission line 330b includes a first end connected to the second coupler 320b. First and second input terminals of the first coupler 340a are connected to second ends of the first and second transmission lines 330a and 330b, respectively. The third transmission line 330c includes a first end connected to the third coupler 320c. The fourth transmission line 330d includes a first end connected to the fourth coupler 320d. First and second input terminals of the second coupler 340b are connected to second ends of the third and fourth transmission lines 330c and 330d, respectively. First and second input terminals of the third coupler 340c are connected to output terminals of the first and second couplers 340a and 340b, respectively, and an output terminal of the third coupler 340c is connected to the error discriminator 380.

The first switch 350a may be installed between the second end of the first transmission line 330a and the ground to selectively ground the first transmission line 330a. When the beamforming circuit 30 needs to determine the amplitude error and the phase error for the first transmission and reception channel 200a, the first switch 350a is turned off so that the first transmission line 330a is activated instead of being grounded. When the amplitude error and the phase error during signal transmission for the first transmission and reception channel 200a are determined, the first RF transmission signal branched by the first coupler 320a may be transferred to the third coupler 360 through the first coupler 340a as a first transmission measurement signal for determining the amplitude error and the phase error. When the amplitude error and the phase error during signal reception for the first transmission and reception channel 200a are determined, the first RF reception signal branched by the first coupler 320a may be transferred to the third coupler 360 through the first coupler 340a as a first reception reference signal for determining the amplitude error and the phase error. Meanwhile, when the beamforming circuit 30 operates in the normal operation mode for transmitting and receiving a beamforming signal or performs error detection for the channels 200b to 200d other than the first transmission and reception channel 200a, the first switch 350a is turned on to ground and deactivate the first transmission line 330a. In this state, the first reception reference signal or the first transmission measurement signal is not transferred to the first coupler 340a and the third coupler 360.

The second switch 350b may be installed between the second end of the second transmission line 330b and the ground to selectively ground the second transmission line 330b. When the beamforming circuit 30 needs to determine the amplitude error and the phase error for the second transmission and reception channel 200b, the second switch 350b is turned off so that the second transmission line 330b is activated instead of being grounded. When the amplitude error and the phase error during signal transmission for the second transmission and reception channel 200b are determined, the second RF transmission signal branched by the second coupler 320b may be transferred to the third coupler 360 through the first coupler 340a as a second transmission measurement signal for determining the amplitude error and the phase error. When the amplitude error and the phase error during signal reception for the second transmission and reception channel 200b are determined, the second RF reception signal branched by the second coupler 320b may be transferred to the third coupler 360 through the first coupler 340a as a second reception reference signal for determining the amplitude error and the phase error. Meanwhile, when the beamforming circuit 30 operates in the normal operation mode for transmitting and receiving a beamforming signal or performs error detection for the channels 200a, 200c, and 200d other than the second transmission and reception channel 200b, the second switch 350b is turned on to ground and deactivate the second transmission line 330b. In this state, the second reception reference signal or the second transmission measurement signal is not transferred to the first coupler 340a and the third coupler 360.

The third switch 350c may be installed between the second end of the third transmission line 330c and the ground to selectively ground the third transmission line 330c. When the beamforming circuit 30 needs to determine the amplitude error and the phase error for the third transmission and reception channel 200c, the third switch 350c is turned off so that the third transmission line 330c is activated instead of being grounded. When the amplitude error and the phase error are determined during signal transmission for the third transmission and reception channel 200c, the third RF transmission signal branched by the third coupler 320c may be transferred to the third coupler 360 through the second coupler 340b as a third transmission measurement signal for determining the amplitude error and the phase error. When the amplitude error and the phase error during signal reception for the third transmission and reception channel 200c are determined, the third RF reception signal branched by the third coupler 320c may be transferred to the third coupler 360 through the second coupler 340b as a third reception reference signal for determining the amplitude error and the phase error. Meanwhile, when the beamforming circuit 30 operates in the normal operation mode for transmitting and receiving a beamforming signal or performs error detection for the channels 200a, 200b, and 200d other than the third transmission and reception channel 200c, the third switch 350c is turned on to ground and deactivate the third transmission line 330c. In this state, the third reception reference signal or the third transmission measurement signal is not transferred to the second coupler 340b and the third coupler 360.

The fourth switch 350d may be installed between the second end of the fourth transmission line 330d and the ground to selectively ground the fourth transmission line 330d. When the beamforming circuit 30 needs to determine the amplitude error and the phase error for the fourth transmission and reception channel 200d, the fourth switch 350d is turned off so that the fourth transmission line 330d is activated instead of being grounded. When the amplitude error and the phase error during signal transmission for the fourth transmission and reception channel 200d are determined, the fourth RF transmission signal branched by the fourth coupler 320d may be transferred to the third coupler 360 through the second coupler 340b as a fourth transmission measurement signal for determining the amplitude error and the phase error. When the amplitude error and the phase error during signal reception for the fourth transmission and reception channel 200d are determined, the fourth RF reception signal branched by the fourth coupler 320d may be transferred to the third coupler 360 through the second coupler 340b as a fourth reception reference signal for determining the amplitude error and the phase error. Meanwhile, when the beamforming circuit 30 operates in the normal operation mode for transmitting and receiving a beamforming signal or performs error detection for the channels 200a to 200c other than the fourth transmission and reception channel 200d, the fourth switch 350d is turned on to ground and deactivate the fourth transmission line 330d. In this state, the fourth reception reference signal or the fourth transmission measurement signal is not transferred to the second coupler 340b and the third coupler 360.

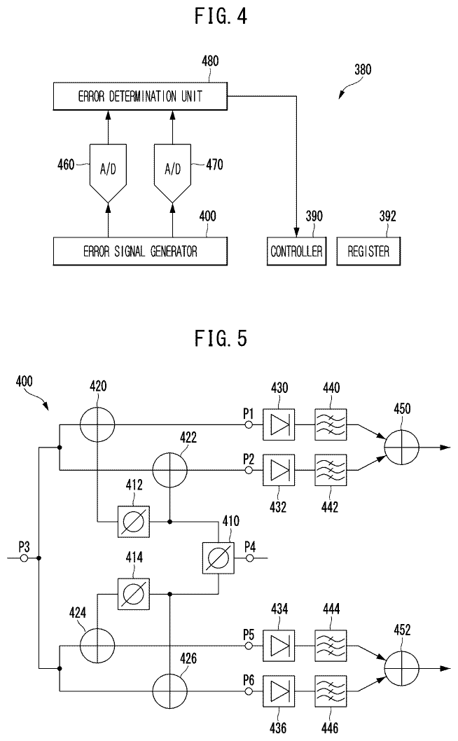

FIG. 4 is a detailed block diagram of the error discriminator 380 illustrated in FIGS. 2 and 3 according to an example embodiment, and FIG. 5 is a detailed block diagram of an error signal generator 400 illustrated in FIG. 4 according to an example embodiment.

Referring to FIG. 4, the error discriminator 380 includes the error signal generator 400, first and second analog-to-digital converters (ADCs) 460 and 470, and an error determination unit 480. The error signal generator 400 may generate I-channel and Q-channel error signals V_{in2ΔI}(t) and V_{in23Q}(t) by additively mixing a measurement signal and reference signals Vᵢₙ₁(t) and Vᵢₙ₂(t), for a transmission or reception operation for each of the transmission and reception channels 200a to 200d. The first and second ADCs 460 and 470 may convert the I-channel and Q-channel error signals V_{in2ΔI}(t) and V_{in2ΔQ}(t), which are analog signals, into digital data, and output I-channel and Q-channel error values I-DATA and Q-DATA, respectively. The error determination unit 480 may determine the amplitude error and the phase error based on the I-channel and Q-channel error values I-DATA and Q-DATA.

Referring to FIG. 5, the error signal generator 400 may include first and second input terminals P5 and P6, first, second, and third phase shifters 410, 412, and 414, first, second, third, and fourth adders 420, 422, 424, and 426, first, second, third, and fourth diodes 430, 432, 434, and 436, first, second, third, and fourth low-pass filters 440, 442, 444, and 446, and first and second subtracters 450 and 452.

The signal Vin (t) branched by the common port coupler 310 illustrated in FIG. 3 may be supplied to a first input terminal P5. The output signal Vᵢₙ₂(t) of the third coupler 360 may be supplied to the second input terminal P6. When the amplitude error and the phase error are determined during signal transmission for any one of the first to fourth transmission and reception channels 200a to 200d, a first input signal Vᵢₙ₁(t) input to the first input terminal P5 is used as the transmission reference signal for determining the amplitude error and the phase error, and a second input signal Vᵢₙ₂(t) input to the second input terminal P6 is used as the transmission measurement signal derived from the signal branched by the coupler of the corresponding channel. Meanwhile, when the amplitude error and the phase error are determined during signal reception for any one of the first to fourth transmission and reception channels 200a to 200d, the first input signal Vᵢₙ₁(t) is used as a reception measurement signal for determining the amplitude error and the phase error, and the second input signal Vᵢₙ₂(t) is used as the reception reference signal derived from the signal branched by the coupler of the corresponding channel.

The first phase shifter 410 shifts a phase of the second input signal Vᵢₙ₂(t) by 90 degrees. The second and third phase shifters 412 and 414 shift an output signal of the first phase shifter 410 by 180 degrees. The first adder 420 adds an output of the second phase shifter 412 to the first input signal Vᵢₙ₁(t). The second adder 422 adds an output of the first phase shifter 410 to the first input signal Vᵢₙ₁(t). The third adder 424 adds an output of the third phase shifter 414 to the first input signal Vᵢₙ₁(t). The fourth adder 426 adds an output of the first phase shifter 410 to the first input signal Vᵢₙ₁(t).

The first, second, third, and fourth diodes 430, 432, 434, and 436 include respective input terminals connected to output terminals of the first, second, third, and fourth adders 420, 422, 424, and 426. Since the first, second, third, and fourth diodes 430, 432, 434, and 436 have input and output characteristics that are close to a quadratic function of calculating a square, the first, second, third, and fourth diodes 430, 432, 434, and 436 pass output signals of the first, second, third, and fourth adders 420, 422, 424, and 426, to square the output signals of the first, second, third, and fourth adders 420, 422, 424, and 426. The first, second, third, and fourth low-pass filters 440, 442, 444, and 446 low-pass filter the outputs of the first, second, third, and fourth diodes 430, 432, 434, and 436, respectively. The first subtractor 450 may subtract an output of the second diode 432 from an output of the first diode 430 to output a subtraction result as an I-channel error signal V_{in2ΔI}(t). The second subtractor 452 may subtract an output of the fourth diode 436 from an output of the third diode 434 to output a subtraction result as a Q-channel error signal V_{in2ΔQ}(t).

As described above, the first and second ADCs 460 and 470 illustrated in FIG. 4 may convert the I-channel and Q-channel error signals V_{in2ΔI}(t) and V_{in2ΔQ}(t) into digital data and output the I-channel and Q-channel error values I-DATA and Q-DATA, respectively. The error determination unit 480 may determine the amplitude error and the phase error based on the I-channel and Q-channel error values I-DATA and Q-DATA.

An operation of the error discriminator 380 as described above will be briefly described mathematically.

It is assumed that the first and second input signals Vᵢₙ₁(t) and Vᵢₙ₂(t) input to the error discriminator 380 are expressed as in Formula 1.

$${V}_{in 1} ( t ) = 2 \cdot {A}_{in 1} \cdot cos ( ω t + θ ) \qquad [ Formula 1 ]$$

$${V}_{in 2} ( t ) = 2 \cdot {A}_{in 2 Δ} \cdot cos ( ω t + φ )$$

Then, the I-channel and Q-channel error signals V_{in2ΔI}(t) and V_{in2ΔQ}(t) output by the error signal generator 400 may be expressed by Formula 2.

$${V}_{in 2 Δ I} ( t ) = 2 β {A}_{in 1} {A}_{in 2 Δ} \cdot cos ( θ + φ ) = 2 β {A}_{in 1} {A}_{in 2 Δ} \cdot cos ( {θ}_{Δ} ) \qquad [ Formula 2 ]$$

$${V}_{in 2 Δ Q} ( t ) = 2 {β}_{Q} {A}_{in 1} {A}_{in 2 Δ} \cdot sin ( θ + φ ) = 2 {β}_{Q} {A}_{in 1} {A}_{in 2 Δ} \cdot sin ( {θ}_{Δ} )$$

Therefore, an amplitude difference and a phase difference between the first and second input signals Vᵢₙ₁(t) and Vᵢₙ₂(t) may be determined by Formulas 3 and 4, respectively.

$$\vert Δ \vert = \sqrt{{{V}_{in 2 Δ I}}^{2} + {{V}_{in 2 Δ Q}}^{2}} \qquad [ Formula 3 ]$$

$${θ}_{Δ} = {tan}^{- 1} ( \frac{{V}_{in 2 Δ Q}}{{V}_{in 2 Δ I}} ) \qquad [ Formula 4 ]$$

In one embodiment, the error determination unit 480 may determine values of the amplitude difference and the phase difference calculated by using Formulas 3 and 4 as the amplitude error and the phase error during transmission or reception of a signal for the corresponding transmission and reception channel. However, in a modified embodiment, in consideration of common signal attenuation and delay in the corresponding transmission and reception channel, the signal distribution and combination circuit 100 and the channel selection and signal detection circuit 300, the error determination unit 480 may add or subtract a predetermined offset to or from the values calculated by Formulas 3 and 4 to determine the amplitude error and the phase error.

Meanwhile, in one embodiment, the error signal generator 400, the first and second analog-to-digital converters ADCs 460 and 470, and the error determination unit 480 may all be included in the error discriminator 380 or the beamforming circuit 30, as illustrated in FIG. 4. However, in a modified embodiment, the first and second analog-to-digital converters ADCs 460 and 470 and the error determination unit 480 may be provided outside the beamforming circuit 30. In particular, the error determination unit 480 may be implemented by the external control device 500.

The beamforming circuit 30 according to the example embodiment operates as follows.

The controller 390 may control the signal distribution and combination circuit 100, the first to fourth transmission and reception channels 200a to 200d, and the channel selection and signal detection circuit 300 based on setting data stored in the register 392.

When the signal transmission and reception device transmits a signal in the normal operation mode, the signal distribution and combination circuit 100 may amplify a transmission signal input through the common port P0 and distribute the amplified transmission signal to the first to fourth transmission and reception channels 200a to 200d. When the signal transmission and reception device receives a signal in the normal operation mode, the signal distribution and combination circuit 100 may combine the first to fourth reception signals received through the transmission and reception channels 200a to 200d, amplify the combined reception signal, and output the resultant reception signal through the common port P0. In the normal operation mode, the channel selection and signal detection circuit 300 may not operate.

In the error detection mode for determining the amplitude error and the phase error for each of the first to fourth transmission and reception channels 200a to 200d, the controller 390 may supply switching control signals for the switches 240a, 210a, 240b, 210b, 210c, 240c, 210d, and 240d installed at both ends of the transmission path and the reception path of the transmission and reception channels 200a to 200d to the channels, and also supply switching control signals for the first to fourth switches 350a to 350d of the channel selection and signal detection circuit 300 to the channel selection and signal detection circuit 300. Accordingly, the amplitude error and the phase error during transmission of the first to fourth transmission and reception channels 200a to 200d may be sequentially determined. Next, the amplitude error and the phase error during reception of the first to fourth transmission and reception channels 200a to 200d may be sequentially determined. The determination of the errors during signal reception may be made before the determination of the errors during signal transmission.

Specifically, when the amplitude error and the phase error during transmission for each of the first to fourth transmission and reception channels 200a to 200d are determined, the controller 390 may first control the switches 240a, 210a, 240b, 210b, 210c, 240c, 210d, and 240d installed at both ends of the transmission path and the reception path of the transmission and reception channels 200a to 200d so that the transmission path can be activated. Next, the controller 390 may control the first to fourth switches 350a to 350d of the channel selection and signal detection circuit 300 so that the first to fourth switches 350a to 350d are turned off. Accordingly, the measurement signal for the transmission and reception channel related to the turned-off switch may be supplied to the error discriminator 380 by the channel selection and signal detection circuit 300, and the amplitude error and the phase error during transmission may be determined by the error discriminator 380.

When the amplitude error and the phase error during reception for each of the first to fourth transmission and reception channels 200a to 200d are determined, the controller 390 may first control the switches 240a, 210a, 240b, 210b, 210c, 240c, 210d, and 240d installed at both ends of the transmission path and the reception path of the transmission and reception channels 200a to 200d so that the reception path can be activated. Then, the controller 390 may control the first to fourth switches 350a to 350d of the channel selection and signal detection circuit 300 so that the first to fourth switches 350a to 350d are turned off. Accordingly, the reference signal for the transmission and reception channel related to the turned-off switch may be supplied to the error discriminator 380 by the channel selection and signal detection circuit 300, and the amplitude error and the phase error during reception may be determined by the error discriminator 380.

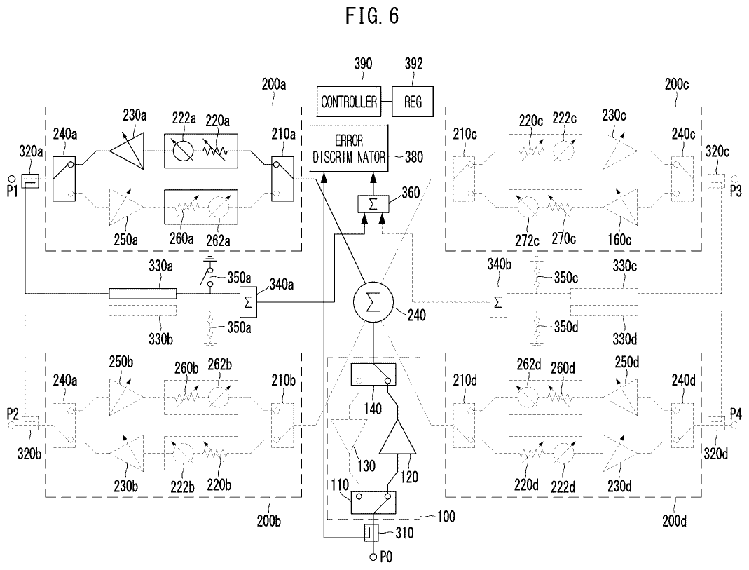

For example, an amplitude error and a phase error during transmission for the first transmission and reception channel 200a may be determined as follows. First, in a state in which the transmission path for the first transmission and reception channel 200a is activated, only the first switch 350a in the channel selection and signal detection circuit 300 is turned off, and the other switches 350b to 350d are turned on. Referring to FIG. 6, the transmission signal input through the common port P0 may pass through the switch 110, the transmission signal amplifier 120, and the switch 140, and be wholly or partially distributed to the first transmission and reception channel 200a by the divider/combiner 150. The first transmission signal distributed to the first transmission and reception channel 200a may pass through the transmission path of the first transmission and reception channel 200a and be supplied to the antenna element as the first RF transmission signal through the first input and output port P1.

In this case, a part of the transmission signal input through the common port P0 is branched by the common port coupler 310 and input to a first input terminal of the error discriminator 380 as the transmission reference signal. Meanwhile, a part of the first RF transmission signal output through the first input and output port P1 is branched by the first coupler 320a and input as the transmission measurement signal to a second input terminal of the error discriminator 380. That is, the first RF transmission signal output through the first input and output port P1 is used as the transmission measurement signal (in this case, Vᵢₙ₁(t)), and the transmission signal input through the common port P0 is used as the transmission reference signal (in this case, Vᵢₙ₂(t)). The error discriminator 380 may determine an amplitude difference |Δ| and a phase difference θ₆₆ between the two signals. The amplitude difference |Δ| and the phase difference θ_{Δ} may be referred to as changes in magnitude and phase of an amplitude of the measurement signal based on the reference signal. The amplitude error and the phase error during reception for the first transmission and reception channel 200a may be determined, for example, through comparison with values stored in the LUT based on the amplitude difference |Δ| and the phase difference θ_{Δ}.

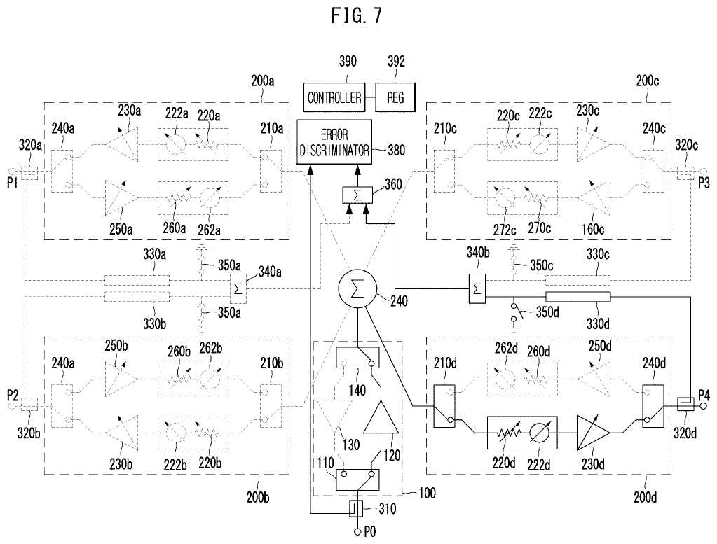

As another example, the amplitude error and the phase error during transmission for the fourth transmission and reception channel 200d may be determined as follows. First, in a state in which the transmission path for the fourth transmission and reception channel 200d is activated, only the fourth switch 350d in the channel selection and signal detection circuit 300 is turned off, and the other switches 350a to 350c are turned on. Referring to FIG. 7, a transmission signal input through the common port P0 may pass through the switch 110, the transmission signal amplifier 120, and the switch 140, and may be wholly or partially distributed to the fourth transmission and reception channel 200d by the divider/combiner 150. The fourth transmission signal distributed to the fourth transmission and reception channel 200d may pass through the transmission path of the fourth transmission and reception channel 200d and be supplied to the antenna element as the fourth RF transmission signal through the fourth input and output port P4.

In this case, a part of the transmission signal input through the common port P0 is branched by the common port coupler 310 and input as the transmission reference signal to the first input terminal of the error discriminator 380. Meanwhile, a part of the fourth RF transmission signal output through the fourth input and output port P4 is branched by the fourth coupler 320d and input as the transmission measurement signal to the second input terminal of the error discriminator 380. That is, the fourth RF transmission signal output through the fourth input and output port P4 is used as the transmission measurement signal (in this case, Vᵢₙ₁(t)), and the transmission signal input through the common port P0 is used as the transmission reference signal (in this case, Vᵢₙ₂(t)). The error discriminator 380 may determine the amplitude difference |Δ| and the phase difference θ_{Δ} between the two signals. The amplitude difference |Δ| and the phase difference θ_{Δ} may be referred to as changes in magnitude and phase of the amplitude of the measurement signal based on the reference signal. The amplitude error and the phase error during reception for the first transmission and reception channel 200a may be determined, for example, through comparison with the values stored in the LUT based on the amplitude difference |Δ| and the phase difference θ_{Δ}.

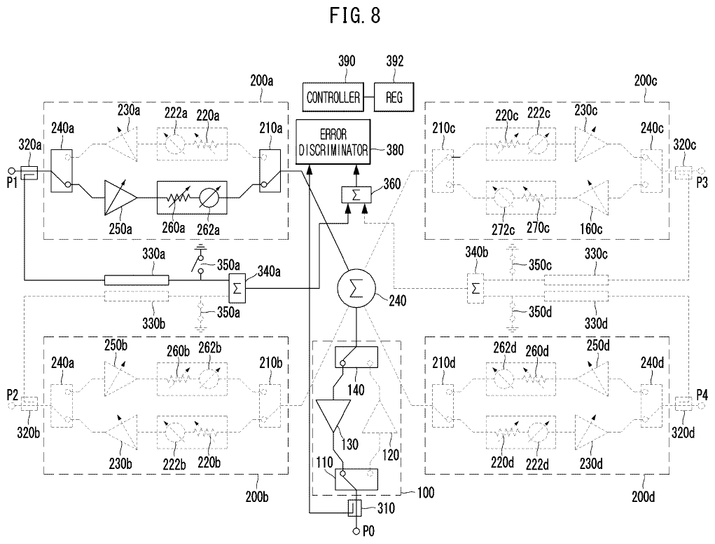

As another example, the amplitude error and the phase error during reception for the first transmission and reception channel 200a may be determined as follows. First, in a state in which the reception path for the first transmission and reception channel 200a is activated, only the first switch 350a in the channel selection and signal detection circuit 300 is turned off and the other switches 350b to 350d are turned on. Referring to FIG. 8, the first RF reception signal received through the first input and output port P1 may pass through the reception path of the first transmission and reception channel 200a, pass through the divider/combiner 150, the switch 140, the reception signal amplifier 130, and the switch 110, and then be supplied as the reception signal to the RF chain 20 through the common port P0.

In this case, a part of the reception signal output through the common port P0 is branched by the common port coupler 310 and input as the reception measurement signal to the first input terminal of the error discriminator 380. Meanwhile, a part of the first RF reception signal received through the first input and output port P1 is branched by the first coupler 320a and input as the reception reference signal to the second input terminal of the error discriminator 380. That is, the reception signal output through the common port P0 is used as the reception measurement signal (in this case, Vᵢₙ₁(t)), and the first RF reception signal received through the first input and output port P1 is used as the reception reference signal (in this case, Vᵢₙ₂(t)). The error discriminator 380 may determine the amplitude difference |Δ| and the phase difference θ_{Δ} between the two signals. The amplitude difference |Δ| and the phase difference θ_{Δ} may be referred to as changes in magnitude and phase of the amplitude of the measurement signal based on the reference signal. The amplitude error and the phase error during reception for the first transmission and reception channel 200a may be determined, for example, through comparison with the values stored in the LUT based on the amplitude difference |Δ| and the phase difference θ_{Δ}.

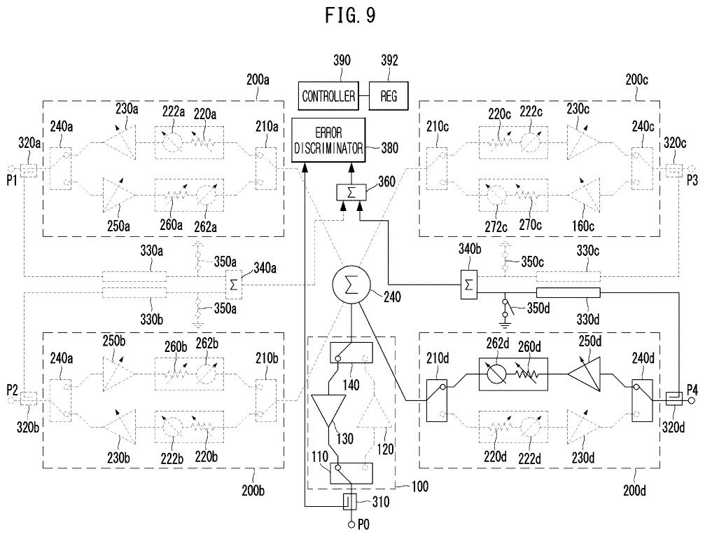

As another example, the amplitude error and the phase error during reception for the fourth transmission and reception channel 200d may be determined as follows. First, in a state in which the reception path for the fourth transmission and reception channel 200d is activated, only the fourth switch 350d in the channel selection and signal detection circuit 300 is turned off, and the other switches 350a to 350c are turned on. Referring to FIG. 9, the fourth RF reception signal received through the fourth input and output port P4 may pass through the reception path of the fourth transmission and reception channel 200d, pass through the divider/combiner 150, the switch 140, the reception signal amplifier 130, and the switch 110, and then be supplied to the RF chain 20 as a reception signal through the common port P0.

In this case, a part of the reception signal output through the common port P0 is branched by the common port coupler 310 and input as the reception measurement signal to the first input terminal of the error discriminator 380. Meanwhile, a part of the fourth RF reception signal received through the fourth input and output port P4 is branched by the fourth coupler 320d and input as the reception reference signal to the second input terminal of the error discriminator 380. That is, the reception signal output through the common port P0 is used as the reception measurement signal (in this case, Vᵢₙ₁(t)), and the fourth RF reception signal received through the fourth input and output port P4 is used as the reception reference signal (in this case, Vᵢₙ₂(t)). The error discriminator 380 may determine the amplitude difference |Δ| and the phase difference θ_{Δ} between the two signals. The amplitude difference |Δ| and the phase difference θ_{Δ} may be referred to as changes in magnitude and phase of the amplitude of the measurement signal based on the reference signal. The amplitude error and the phase error during reception for the first transmission and reception channel 200a may be determined, for example, through comparison with the values stored in the LUT based on the amplitude difference |Δ| and the phase difference θ_{Δ}.

Thus, according to an example embodiment of the present disclosure, one of the plurality of transmission and reception channels is selected, and a phase difference and an amplitude difference between a signal detected by a coupler of an input and output port Pi associated with the channel and the signal detected by the common port coupler 310 are discriminated. When measurement and an error determination are sequentially performed for all transmission and reception channels in a state in which other transmission and reception channels are turned off, that is, deactivated, absolute values of the amplitude difference and the phase difference may be obtained for all the transmission and reception channels. The absolute values of the amplitude difference and the phase difference for each transmission and reception channel may be compared with, for example, the values stored in the LUT to determine the amplitude error and the phase error of the channel.

According to the present disclosure, it is not necessary to repeatedly perform measurement and error determination to obtain a relative amplitude and phase differences between the channels, and it is possible to immediately acquire the amplitude error and the phase error of each channel based on the signals measured at the input and output ports, and to minimize a calibration time.

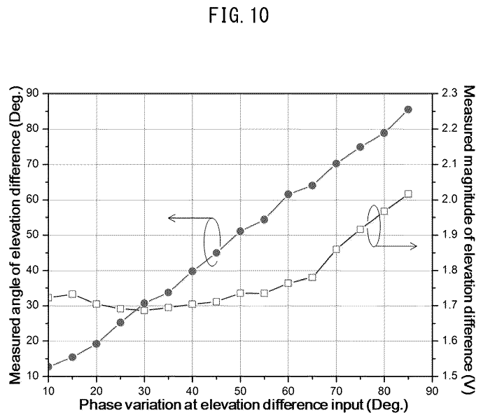

FIG. 10 is a graph showing measurement results for the amplitude error and the phase error during reception for the first transmission and reception channel 200a. In FIG. 10, a phase of the first RF reception signal was changed so that a phase of the reception reference signal Vᵢₙ₂(t) was changed from 10 degrees to 85 degrees, to measure the amplitude error and the phase error. It was confirmed that the measured phase error was consistent with a calculation result.

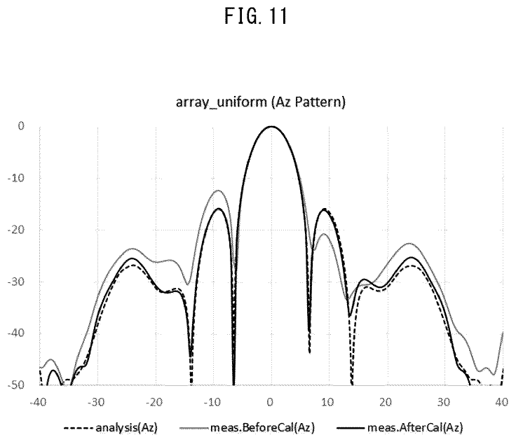

FIG. 11 shows an antenna radiation pattern when a beamforming circuit calibration method according to an example embodiment is applied to the array antenna. It was confirmed that a size of a side lobe could be significantly reduced.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A beamforming device comprising:
a common port configured to receive a transmission signal and output a reception signal to the outside;
a plurality of input and output ports connected to corresponding antenna elements and configured to output a radio frequency (RF) transmission signal to the corresponding antenna elements and receive an RF reception signal from the antenna elements;
a plurality of transmission and reception channels connected to corresponding input and output ports among the plurality of input and output ports and configured to attenuate and phase-shift respective channel transmission signals to generate the RF transmission signal, and attenuate and phase-shift the RF reception signal from the corresponding input and output ports to generate respective channel reception signals;
a common port coupler coupled to the common port and configured to provide a first measurement signal representing the transmission signal or the reception signal;
a plurality of channel input and output couplers coupled to the plurality of input and output ports;
a channel selection and signal detection circuit configured to select one of the plurality of transmission and reception channels and acquire a second measurement signal detected by a channel input and output coupler associated with the selected transmission and reception channel; and
an error discriminator configured to determine an amplitude difference and a phase difference between the first measurement signal and the second measurement signal based on mixing of the first and second measurement signals.

2. The beamforming device of claim 1, wherein the error discriminator includes
an error signal generator configured to mix the first and second measurement signals to generate an I-channel error signal and a Q-channel error signal; and
an analog-to-digital conversion circuit configured to perform analog-to-digital conversion on the I-channel error signal and the Q-channel error signal to generate an I-channel error value and a Q-channel error value.

3. The beamforming device of claim 2, wherein the error signal generator generates the I-channel error signal and the Q-channel error signal by additively mixing the first measurement signal and the second measurement signal.

4. The beamforming device of claim 2, wherein the error discriminator determines the amplitude difference and the phase difference based on the I-channel error value and the Q-channel error value, and determines the amplitude error and the phase error based on the amplitude difference and the phase difference.

5. The beamforming device of claim 2, further comprising a controller configured to control an operation of the beamforming device,
wherein the error signal generator outputs the I-channel error value and the Q-channel error value to an external control device configured to determine the amplitude difference and the phase difference, and
the controller receives an attenuation amount and a phase shift amount corresponding to the amplitude difference and the phase difference from the external control device, stores the attenuation amount and the phase shift amount in a storage device, and controls the plurality of transmission and reception channels based on the attenuation amount and the phase shift amount.

6. The beamforming device of claim 5, wherein the controller controls the beamforming circuit so that the beamforming circuit sequentially acquires the amplitude difference and the phase difference for each of the plurality of transmission and reception channels.

7. The beamforming device of claim 1, wherein the channel selection and signal detection circuit deactivates paths of outputs of channel input and output couplers associated with the transmission and reception channels not selected among the plurality of transmission and reception channels.

8. The beamforming device of claim 1, wherein the control unit controls the channel selection and signal detection circuit so that the error discriminator separately determines the amplitude difference and the phase difference for signal transmission and signal reception.

9. A method of calibrating an amplitude error and a phase error between a plurality of transmission and reception channels in signal transmission and reception using beamforming, the method comprising:
coupling a common port coupler to a common port configured to receive a transmission signal and output a reception signal to the outside, to acquire a first measurement signal;
selecting any one of the plurality of transmission and reception channels configured to attenuate and phase-shift each channel transmission signal to generate a radio frequency (RF) transmission signal, output the RF transmission signal to a corresponding antenna element, receive an RF reception signal from the corresponding antenna element, and attenuate and phase-shift the RF reception signal, and acquiring a second measurement signal detected by a channel input and output coupler associated with the selected transmission and reception channel; and
mixing the first and second measurement signals to determine an amplitude difference and a phase difference between the first measurement signal and the second measurement signal.

10. The method of claim 9, wherein the determining of the amplitude difference and the phase difference includes:
additively mixing the first measurement signal and the second measurement signal to generate an I-channel error signal and a Q-channel error signal;
performing analog-to-digital conversion on the I-channel error signal and the Q-channel error signal to generate an I-channel error value and a Q-channel error value; and
determining the amplitude difference and the phase difference based on the I-channel error value and the Q-channel error value.

11. The method of claim 10,
wherein the determining of the amplitude difference and the phase difference further includes determining an attenuation amount and a phase shift amount corresponding to the amplitude difference and the phase difference, respectively; and
operations of the plurality of transmission and reception channels are controlled based on the attenuation amount and the phase shift amount.

12. The method of claim 9, wherein the amplitude difference and the phase difference are sequentially determined for the plurality of transmission and reception channels.

13. The method of claim 9, wherein the acquiring of the second measurement signal includes deactivating paths of outputs of channel input and output couplers associated with the transmission and reception channels not selected among the plurality of transmission and reception channels.

14. The method of claim 9, wherein the amplitude difference and the phase difference are separately determined for signal transmission and signal reception.

15. A signal transmission and reception device comprising:
a baseband signal processing unit configured to perform digital signal processing on transmission data and reception data in a baseband;
an RF chain configured to perform digital-to-analog conversion on the transmission data, modulate an obtained analog signal to generate a transmission signal, demodulate a reception signal, and perform analog-to-digital conversion on the reception signal to restore the reception data;
an array antenna including a plurality of antenna elements; and
a beamforming circuit including a plurality of transmission and reception channels corresponding to the plurality of antenna elements, the beamforming circuit distributing the transmission signal to the plurality of transmission and reception channels, performing signal attenuation and phase shift individually for each transmission and reception channel to generate RF transmission signals, supplying the RF transmission signals to corresponding antenna elements, receiving an RF reception signal from the corresponding antenna element for each transmission and reception channel, performing signal attenuation and phase shift on the RF reception signal, and combining the attenuated and phase-shifted signals for the plurality of transmission and reception channels to generate the reception signal,
wherein the beamforming circuit includes
a common port configured to receive the transmission signal and output the reception signal to the RF chain;
a plurality of input and output ports connected to the corresponding antenna element and configured to output the RF transmission signal to the corresponding antenna element and receive the RF reception signal from the antenna element;
a common port coupler coupled to the common port and configured to provide a first measurement signal representing the transmission signal or the reception signal;
a plurality of channel input and output couplers coupled to the plurality of input and output ports;
a channel selection and signal detection circuit configured to select any one of the plurality of transmission and reception channels and acquire a second measurement signal detected by a channel input and output coupler associated with the selected transmission and reception channel; and
an error discriminator configured to determine an amplitude difference and a phase difference between the first measurement signal and the second measurement signal based on mixing of the first and second measurement signals.

16. The signal transmission and reception device of claim 15, wherein the error discriminator includes
an error signal generator configured to additively mix the first and second measurement signals to generate an I-channel error signal and a Q-channel error signal; and
an analog-to-digital conversion circuit configured to perform analog-to-digital conversion on the I-channel error signal and the Q-channel error signal to generate an I-channel error value and a Q-channel error value.

17. The signal transmission and reception device of claim 16, wherein the error discriminator determines the amplitude difference and the phase difference based on the I-channel error value and the Q-channel error value, and determines the amplitude error and the phase error based on the amplitude difference and the phase difference.

18. The signal transmission and reception device of claim 16,
wherein the beamforming circuit further includes a controller configured to control an operation of the beamforming device,
the signal transmission and reception device further includes an external control device configured to determine the amplitude difference and the phase difference based on the I-channel error value and the Q-channel error value, and
the controller receives an attenuation amount and a phase shift amount corresponding to the amplitude difference and the phase difference from the external control device, stores the attenuation amount and the phase shift amount in a storage device, and controls the plurality of transmission and reception channels based on the attenuation amount and the phase shift amount.

19. The signal transmission and reception device of claim 18, wherein the controller controls the beamforming circuit so that the beamforming circuit sequentially acquires the amplitude difference and the phase difference for each of the plurality of transmission and reception channels.

20. The signal transmission and reception device of claim 15, wherein the channel selection and signal detection circuit deactivates paths of outputs of channel input and output couplers associated with the transmission and reception channels not selected among the plurality of transmission and reception channels.
